(19) United States
(12) Patent Application Publication
(10) Pub. No.: US 2013/0137871 A1
(43) Pub. Date: May 30, 2013

(54) METHOD OF SYNTHESIZING A COMPLEX [MN (NNS)2] ACTIVE AGAINST THE MALARIA PARASITE PLASMODIUM FALCIPARUM

(71) Applicant: Enos Kiremire, Windhoek (NA)

(72) Inventor: Enos Kiremire, Windhoek (NA)

(21) Appl. No.: 13/642,615

(22) PCT Filed: Nov. 19, 2010
(86) PCT No.: PCT/IB10/55286

§ 371 Date: Dec. 28, 2012

(30) Foreign Application Priority Data
Apr. 23, 2010 (NA) 2010/0008

(51) Int. Cl. C07F 13/00

(52) U.S. Cl. CPC C07F 13/00
USPC 546/6

(57) ABSTRACT

Metal complex of Manganese(II) containing a dithio-based ligand have been synthesized and characterized by elemental analysis, mass spectrometry, Proton NMR and FT-IR spectrometry. A single crystal X-ray structure of the cadmium complex has been analyzed. The metal complex was subjected to biological tests on falcipain-2 (FP-2) and falcipain-3 (FP-3) cysteine protease enzymes from the malaria parasite Plasmodium falciparum. They were further tested in vitro against chloroquine resistant strain (W2). Whereas the potency of the metal complexes was weaker than the control regarding the FP-2 and FP-3, the potency of metal complexes was found to be exceedingly greater than the control when tested against the chloroquine resistant strain (W2) with a strength ratio of 132.2 This paper describes the synthesis, characterization and biological results of the said metal complex containing deprotonated 3-[1-(2-pyridyl)ethylidene]hydrazinecarbodithioate ligand (FIG. 1).

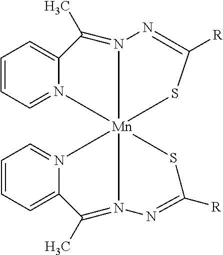

### RELATED ART

Malaria annually kills more than one million people world-wide 90% of them in Africa. The eradication of malaria continues to be frustrated by the continued drug resistance of the malaria parasite. Hence, there is a great need to continue the search for more effective drugs in terms of activity and the cost. The use of metal complexes as pharmaceuticals has shown promise in recent year's particularly as anticancer agents and as contrast agents for magnetic resonance imaging. In the search for novel drugs against resistant parasites, the modification of existing drugs by coordination to metal centers has attracted considerable attention. However, the potential of metal complexes as antiparasitic agents has far been very little explored. As part of our research to develop metal complexes with potential antiprotozoal activities, we present the synthesis and characterization of metal complex of MnL₂ with high biological activity against the chloroquine resistant strain of the plasmodium falciparum parasite.

### BRIEF DESCRIPTION OF INVENTION

The present invention overcomes these problems in the prior art.

The metal complexes were synthesized and recrystallized. They were sent for spectroscopic measurements. The elemental analyses were performed by using an EA 1108 CHNS-O instrument. The proton NMR was recorded at ambient temperature with Varian mercury (300 MHz) or Varian Unity Spectrometer (400 MHz) and TMS was used as an internal reference. The chemical shifts ( ) are given in parts per million relative to TMS (=0.00). The mass spectra were recorded by means of a low resolution mass spectroscopy apparatus. The infrared spectra were measured in solution using chloroform on a satellite Perkin-Elmer FT-IR spectrophotometer.

The current invention presents the synthesis and characterization of a metal complex MnL₂. The manganese salt MnCl2.4H2O (0.23 g) was dissolved in water (20.0 cm3). The ligand (0.50 g) was also dissolved in ethanol. The two solutions were then mixed. The brown complex formed was filtered off, washed with water, ethanol and ether. It was then dried at the water pump giving a yield of 0.60 g. The product was then recrystallized from chloroform. Yield 0.50 g (89%). Thiosemicarbazones and their corresponding thiosemicarbazides containing 2-acetylpyridine fragment have been found to show biological activity against malaria parasites, trypasomiasis, bacteria, and viruses. Our current findings indicate that the metal complexes containing the dithioester 3-[1-(2-pyridyl)ethylidene]hydrazinecarbodithioate have moderate potency against falcipain-2 (FP-2) and falcipain-3 (FP-3) cysteine protease enzymes from the malaria parasite plasmodium falciparum while they portray enormous potency against the chloroquine resistant strain (W2) of the parasite. This patent describes the synthesis, characterization and biological results of metal complexes containing de-protonated 3-[1-(2-pyridyl) ethylidene] hydrazinecarbodithioate ligand (FIG. 1). The metal complex were synthesized and recrystallized. The biological activities (nanomolar) of the metal complex against malaria parasites were tested and tabled as table 1 in FIG. 6 of the drawings. According to the method of the invention the metal potency was far much greater than the control drug with respect to W-2. This observation is extremely important as malaria resistance against the chloroquine drug is a great challenge today. This metal complex may act as lead compounds for developing future malaria drugs. The potency of the metal complex is modest and less than that of the control drug with respect to FP-2 and FP-3 cysteine protease enzymes. The method of the invention further establishes the potency of manganese is greater with respect to W-2 compared to other metals such as Cobalt (Co), Nickel (Ni) and Iron (Fe) as well as the control drug. According to the method of the invention the metal complex MnL₂ containing the deprotonated dithioester L− have been synthesized and characterized by elemental analysis, mass spectrometry, proton NMR and Fourier transform IR. The ligand LH undergoes tautomerism which can readily get ionized to generate a de-protonated ligand L−. Both LH and L− are potentially tridentate via the pyridine ring nitrogen, the methine nitrogen (-nitrogen) and the sulphur (mercapto sulphur) atom. FIG. 2 shows the deprotonation process and mode coordination of L−. The analytical data and molecular masses of the complexes are given in FIG. 5, Table 1. This information is consistent with the formulation of the synthesized complex as ML₂ (M=Mn)

The x-ray single crystal structure analysis was done for MnL₂ complex. The infrared spectra of metal complex is given in FIG. 8. The HNMR of the metal complex is given in FIG. 7. the The structure is a distorted octahedral geometry and indicates that the L− behaves as a tridentate ligand (NNS). It is quite clear from the method of the invention that the fragmentation of the complexes involved the bound deprotonated ligand L−. The main decomposition points are indicated in FIGS. 3 as 1, 2, 3, 4 and 5.

The coupling of the pyridine hydrogen rings according to FIG. 4.

The results of the biological activities of the metal complexes against malaria parasites are shown in FIG. 6, Table 1 . The metal complex was tested against two cysteine protease enzymes falcipain-2 (FP-2) and falcipain-3 (FP-3) as well as the chloroquine-resistant strain from the malaria parasite Plasmodium falciparum. The following activity sequences can be discerned.

FP-2: CONTROL>Mn

FP-3: CONTROL>Mn

W-2 Mn>CONTROL

The method of the invention further establishes that although the metals were bound to the same ligand, L−, their activities differed dramatically. MnL₂ complex yielded a nanomolar ratio of 11,220 against FP-2 and 10,440 against FP-3 and 18, 8 against W2 and a strength ratio of 132, 0 against W-2. According to the method of the invention it is quite clear from our work that keeping the ligand constant and varying the central metal atom, affects the biological activity of the complex. It is also well known that a change in molecular structure may influence its biological activity dramatically. The biological activity may either remain the same, decrease, increase or disappear completely. This has been observed in thiosemicarbazones and thiosemicarbazides in the malaria studies. For instance, the 2-acetylpyridine moiety in thiosemicarbazones has been found to be crucial in promoting the biological activity against malaria parasites and Trypanosoma rhodesiense and so was the presence of the sulphur atom. The modifications at the pyridine nitrogen and/or the terminal nitrogen (N4) of the thiosemicarbazone chain also affected the biological activity against malaria, trypanosomiasis, and Herpes Simplex Virus. The molecular geometry is also crucial in determining the biological activity in metal complexes.

This is illustrated by cis-[PtCl₂(NH₃)₂] (Cisplatin) is biologically active and used as a drug against cancer whereas the trans isomer is biologically inactive against cancer. Dissociative mechanism of the Cl ligands was advanced to explain the anti-tumor activity in cis-[PtCl₂(NH₃)₂] complex. In this mechanism one of the Cl ligand is replaced by water to form [Cl(H₃N)₂Pt(OH₂)]⁺ complex. Then the platinum aquo complex reacts further with a DNA ‘molecule’ of the cancerous cell to form the new complex [Cl(H₃N)₂Pt(DNA)]⁺ and in so doing terminates or minimizes the cancerous growth. The DNA molecule binds the platinum metal via the guanine moiety. Green and Berg also observed that the retroviral nucleocapsid from the Rauscher murine leukemia binds to metal ions, in particular, it has a higher affinity ²⁶ for Co²⁺ and Zn²⁺. In this case the nucleocapsid behaves as a ‘ligand’ for the metal ions. It is also very interesting to note that complexation mechanism has been advanced to explain the antimalarial activity of chloroquine. It does this by binding the heme fragments and th ereby preventing the crucial polymerization process of the parasite. This ultimately leads to the death of the parasite. In this case the chloroquine molecule acts as a ligand to bind the biological heme fragment. Circular dichroism studies of [MLCl] (M=Pd, Pt, L=methyl-3-[2-pyridylmethylene]hydrazinecarbodithioate ion) with DNA also indicate that an adduct is formed between the two moieties. Biological activities of certain thiosemicarbazone ligand complexes were found to be less active against malaria parasites than other ligands. On the other hand, it was observed that metal complexes of pyridoxal semicarbazones, thiosemicarbazones and isothiosemicarbazones were more biologically active than the others ligands.

### Possible Mechanism of the Biological Activity of MnL₂ Complex

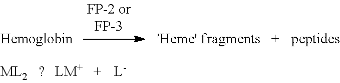

Interactions with the ‘Heme’ Fragment

LM⁺+‘Heme’→[LM-Heme]⁺ complex

L⁻+‘Heme’→2

ML₂+‘Heme’→‘Heme’-ML₂ complex

Scheme 1. The Interactions of the [symbol] Ligandmetal Complex [symbol] FragmentsMLML⁺ with the Heme Fragment.

Interactions with FP-2 Cysteine Protease Enzyme

LM⁺+FP-2→[LM-FP-2]⁺ complex

L⁻+FP-2→[L-FP-2]⁻ complex

ML₂+FP-2→FP-2-ML₂ complex

Scheme 2. The Interactions of the [symbol] Ligandmetal Complex Fragments [symbol] MLML⁺ with FP-2 Protease Enzyme.

Interactions with FP-3 Cysteine Protease Enzyme

LM⁺+FP-3→[LM-FP-3]⁺ complex

L⁻+FP-3→[L-FP-3]⁻ complex

ML₂+FP-3→FP-3-ML₂ complex

Scheme 3. The Interaction of FP-3 Protease Enzyme with the [symbol] Ligand L and metal complex fragments, ML₂ and ML⁺.

Interactions with W-2

LM⁺+W-2→[LM-W-2]⁺ complex

L⁻+W-2→[L-W-2]⁻ complex

ML₂+W-2→W-2-ML₂ complex

Scheme 4. The Interaction of W-2 with the [symbol] Ligandand Metal Complex Fragments, ML₂ and ML⁺

Interactions with WE-2

LM⁺+WE-2→[LM-WE-2]⁺ complex

L⁻+WE-2→[L-WE-2]⁻ complex

ML₂+WE-2→WE-2-ML₂ complex

Scheme 5. The Interaction of WE-2 with the [symbol] Ligandand Metal Complex Fragments, ML₂ and ML⁺.

The corresponding atoms of the NNS ligands are trans to each other in a distorted manner. That is, the sulphur atoms, the pyridine ring nitrogen's and the imine nitrogen's. According to the method of the invention the degree of M-L bond strength could affect bond dissociation and hence the degree of biological activity.

In addition, the method herein presented further suggests that other factors such the lability and the size of the metal atom could influence the biological activity.

For instance, Mn(II)>Zn(II)>Co(II)>Ni(II) in size. This more or less parallels the order for complex reactivity of ML₂ with W-2. The dramatic variation in the biological activity of the complexes implies a direct participation of the metal atom. Hence, it is more plausible to assume that ML+ fragment probably exerts more influence in the biological activity than the ligand L−, and ML₂ complex. In conclusion, a lot more extensive work is needed to clearly understand the factors and mechanisms that influence the biological activity of the ligand, L− and its corresponding metal complex, ML₂ . The proposed possible mechanisms by which the metal complexes affect the parasite are summarized in Schemes 1 to 5 and condensed in Scheme 6. The malaria parasite decomposes human hemoglobin to produce free heme fragments and peptides in its food vacuole. The proteins are utilized by the parasite for its growth and replication. The heme acts as a parasite waste and is thus toxic to the parasite. Its toxicity is thought to occur by the heme lysing the membranes and producing reactive oxygen intermediates (ROI) and interfering with other biochemical processes. The parasite neutralizes the toxicity of the heme by converting it into a hemazoin polymer also known as the malarial pigment through a process called biocrystallization. The action of chloroquine drug is its interference with these processes. Chloroquine enters the food vacuole of the parasite due to its enabling environment. The enabling environment includes the parasite transporters that assist in the uptake of chloroquine, the existence of a specific parasite receptor for binding chloroquine and acidity of the food vacuole that promotes the protonation of the chloroquine nitrogen atoms. A postulated mechanism by which this activity occurs is through the formation of a complex with the heme and hence preventing it from forming a non-poisonous hemozoin The complex formed between the heme and chloroquine is poisonous to the parasite. This results into the death of the parasite.

The mechanism we have proposed in schemes 1 to 5 involve the formation of complexes between the complex ML₂, the fragments ML+ and the ligand L− on one hand with the parasite enzymes FP-2 and FP-3, the heme, as well as the chloroquine resistant strain W-2 and its enzymes represented by WE-2 on the other. The complexes so formed will ultimately poison the parasite leading to its death.

### BRIEF EXPLINATION OF DRAWINGS

FIG. 1. Refers to the synthesis, characterization and biological results of metal complex containing deprotonated 3-[1-(2-pyridyl) ethylidene]hydrazinecarbodithioate ligand (FIG. 1).

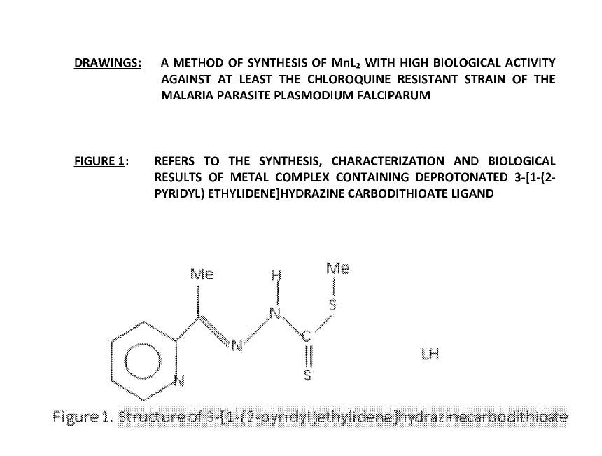

FIG. 2. Refers to the deprotonation process and mode of of coordination of 1-.

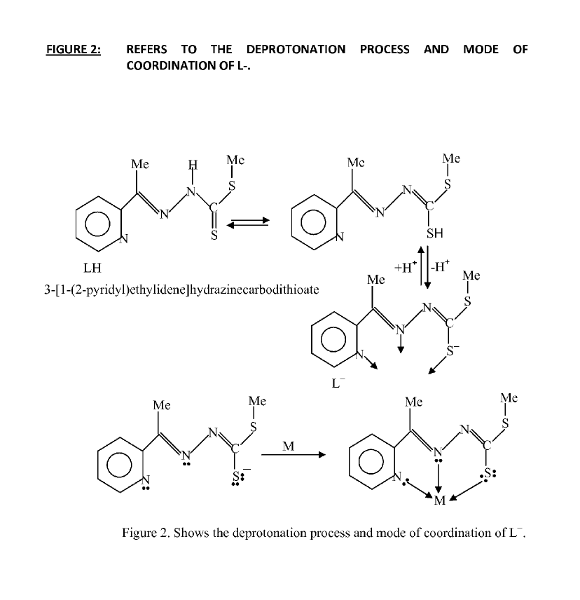

FIG. 3. Refers to positions where fragmentations can occur.

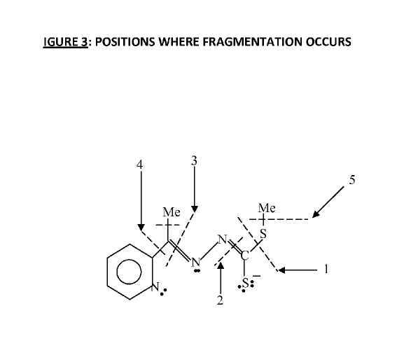

FIG. 4. Refers to the coupling of the pyridine hydrogens.

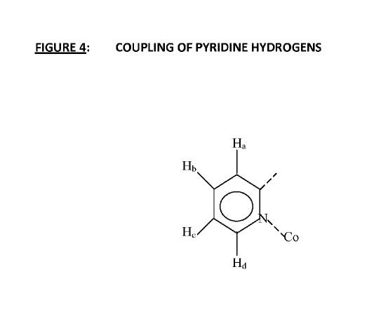

FIG. 5. Refers to the analytical data of and molecular mass of the complex charachterized.

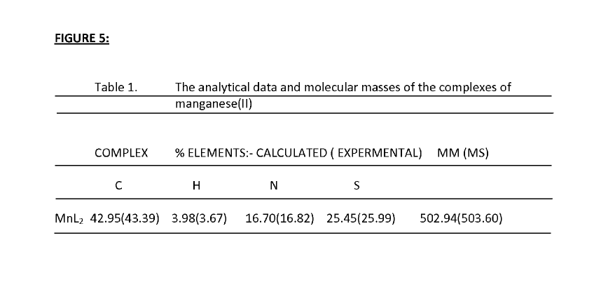

FIG. 6. Refers to the biological activity of the metal complex compared to the control drug.

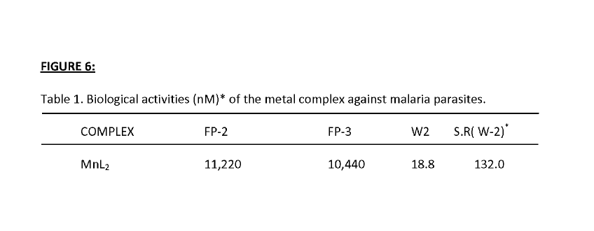

FIG. 7 The Infrared Spectra of the metal Complex.

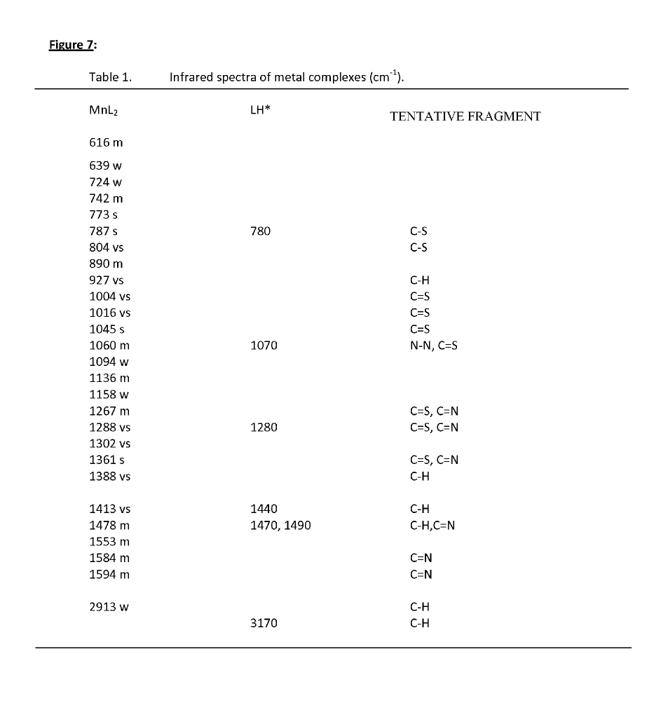

FIG. 8 The HNMR of the metal complex.

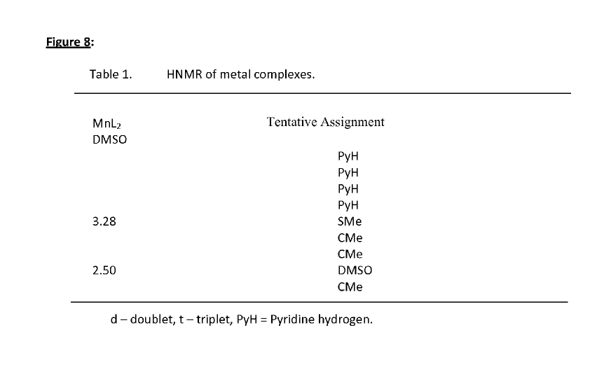

1-44. (canceled)

45. A method of producing a manganese ligand complex (MnL₂) having biological activity against a malaria parasite includes providing a source of 3-[1-(2-pyridyl) ethylidene]hydrazinecarbodithioate ligands (L), deprotonating the ligands to form deprotonated ligands (L−), contacting the deprotonated ligands with a manganese compound under conditions suitable to form the manganese ligand complex, and recovering the manganese ligand complex so formed.

46. A method according to claim 45, wherein the manganese compound is manganese chloride tetrahydrate.

47. A method according to claim 45, wherein the source of ligands (L−) and manganese compound are provided respectively in solution, the respective ligand and manganese solutions being mixed together to form a precipitate of the manganese ligand complex.

48. A method according to claim 47, wherein the manganese compound is dissolved in water to form the manganese solution and the source of ligands is dissolved in ethanol to form the ligand solution.

49. A method according to claim 47, wherein the manganese ligand complex precipitate is filtered off, washed, dried, and then recrystallized.

50. A method according to claim 49, wherein the manganese ligand complex precipitate is recrystallized from acetone.

51. A method according to claim 45, wherein the manganese ligand complex is potent against the malaria parasite plasmodium falciparum.

52. A method according to claim 45, wherein the manganese ligand complex is potent against the chloroquine resistant strain (W-2) of the malaria parasite plasmodium falciparum.
